(19) United States
(12) Patent Application Publication
(10) Pub. No.: US 2007/0050230 A1
(43) Pub. Date: Mar. 1, 2007

(54) Computer facilitated ordering, tracking, and reporting system

(76) Inventor: Randolph G. Umagat, Seal Beach, CA (US)

Correspondence Address: Alvin Viray, PO BOX 4351, Irvine, CA, 92616, US

(21) Appl. No.: 11/513,620

(22) Filed: Aug. 31, 2006

Related U.S. Application Data
(60) Provisional application No. 60/713,436, filed on Aug. 31, 2005.

(51) Int. Cl. G06Q 99/00; G06F 15/02; H04M 3/51; G06F 9/46

(52) U.S. Cl. 705/9; 705/1; 705/11

(57) ABSTRACT

An apparatus and process programmed by an administrator for allowing users to track service related information, including equipment, labor, location, profit, warranties, and costs. For example, the system allows a customer to visit a website on a computer network, such as the internet, and request a new work order or view past work orders. A customer can generate reports based on one or more contractors, and determine the cost of equipment and labor over any given time. The customer can compare pricing or be alerted to disparate pricing. A contractor can view profit information by one or more customers, locations, employees, or work orders. The system is designed so that a customer requests work orders from the administrator, who then dispatches contractor. Contractor may purchase equipment from administrator, who may purchase the equipment in advance, in bulk, and at a negotiated discount to retail prices. Administrator bills the customer and pays the contractor. Thus, the system allows administrator to set the appropriate pricing structure and profit accordingly. By subcontracting the work orders, the contractor may himself become an administrator. The apparatus and system is designed to work with existing internet enabled devices, and the customer or contractor is not required to purchase software or hardware from the administrator in order to effect the system.

### REFERENCE TO RELATED APPLICATIONS

This Application claims priority to U.S. Provisional Patent Application No. 60/713,436 filed on Aug. 31, 2005. The '436 Application is incorporated by reference as if set forth fully herein.

### FIELD OF THE INVENTION

This invention relates generally to a electronic system for ordering, tracking, and reporting information related to services performed by a contractor for a customer.

### BACKGROUND OF THE INVENTION

A customer may need the services of a contractor for any number or reasons. For example, the customer may have equipment that is in need of maintenance or repair. Such equipment includes, but is not limited to, household or industrial heaters, vacuum, and air conditioners (HVAC). A customer may also need service in the form of labor such as housekeeping, day care, plumbing, or computer programming. For the customer and contractor, it is desirable to track and report those services that occur on a regular basis.

With the advent of the internet, customers can request service online if the contractor's website has such a feature. After performing the service however, the contractor will submit to customer a paper invoice itemizing any parts, labor, and costs. Even though the contractor may enter the information into their own computers for record keeping and invoicing purposes, they do not share this electronic format with the customer. The customer would need a system in place to manually input the information into their own database, costing time and money.

Large customers may be in need of recurring services in one or more locations. A business or commercial customer with many stores may have, for example, one or more HVAC equipment in need of preventive maintenance or repair. These large customers may have several service calls being performed at different locations with multiple contractors at the same time. Within months, a large customer can collect many paper invoices that take up space and can be lost or destroyed. Manually inputting the information from these paper invoices to an electronic database would be expensive and time consuming.

It would be advantageous to have a system in place wherein one can order or perform a service call and track the related information conveniently and electronically, and to generate customizable reports or histories based on the information. Such a history or report may be specific to one or more customers, contractors, equipment, locations, period of time, or any combination thereof. For example, customer may desire to generate a specific report to show, over a specific period of time, which equipment was repaired or replaced, and how much it cost to do so. A report may also show how much the contractor profited from the service call, how much labor was performed, and which technicians are the most productive. Reports could help a customer easily compare and identify: contractors who may be charging more than others; equipment that may be costing more to repair than to replace; or particular locations that are more costly than others. In addition, by viewing when and how often certain equipment needs to be repaired or replaced, such a report can identify the reliability of certain manufacturers. It may also show seasonal or weather related patterns for equipment or locations. A report would be advantageous to track customers or locations that require a regular supply of parts. Armed with this information, parts can pre-order in bulk and at a negotiated discount to retail prices. Similarly, the labor performed by one or more contractors can be tracked, and a lower rate can be negotiated if a large amount of labor is regularly required.

Because of the volume of services that large customers have need for, some of the labor and equipment may still be under warranty when a repair is needed. However, these customers cannot adequately and easily track this information and will rely on the contractor to inform them that a warranty still exists. Unscrupulous contractors may not notify the customer. Some contractors may not have easy access to this information themselves, and may not check warranties unless claimed by a customer. What is also needed is a way to easily track and access warranty information for numerous equipment and contractors.

Another drawback to being a large customer is that one often pays without question the contractor invoice. This is true even though “accidental” pricing typos or input errors occur more often than not. It would be desirable for customers to adequately and easily compare the cost of similar equipment and parts from the same contractor, across different contractors, or the national average. It would be further desirable to be notified if a price discrepancy occurs. In this manner, contractors can be held accountable for their costs, and will minimize the practice of overpricing.

Thus, it is desirable for large customers to have a convenient means of ordering, tracking, and reporting the service information electronically via a user friendly interface. The invention contained herein satisfies these critical needs.

### SUMMARY OF THE INVENTION

This invention relates generally to a system for ordering, tracking, and reporting information related to services performed by a contractor for a customer. The system allows a customer to visit a website on a computer network, such as the internet, and request new services or view information on past service calls. The system allows the service provider, or contractor, a means for responding to new service calls and convenient purchasing of any needed equipment and parts. Via global positioning satellites, the system also allows for tracking a contractor's location and route to one or more service calls. An administrator programs a computer to manage the flow of information by receiving the service call from customer and dispatching the contractor. If needed, the system assists in the selection of the contractor used to perform the service. Administrator determines the pricing structure and the payments from the customer and to the contractor. Customizable reports or histories can be generated to show make and model of equipment, location, costs, date initially installed and serviced, and warranty information. Reports can also display labor information such as cost per hour and number or hours spent on one or more service calls. Reports can also display the amount of profit received by a contractor for providing services to a particular customer. Thus, the invention contained herein advantageously provides for an electronic system for ordering services, responding to and performing the services, tracking the information related thereto, and generating customizable reports based on the information via a user friendly interface. By using this system, a contractor and customer may not need their own internal service tracking system.

For example, the invention contained herein provides a computer system for allowing users to enter and access information associated with the maintenance, repair, and/or replacement of equipment. The equipment can be any machine, apparatus, or material that can be used by a customer or serviced by a contractor, including, but not limited to, heating, ventilation, air conditioning, and refrigeration equipment (HVAC-R). The information accessed and displayed can be customizable by selecting data related to one or more customers, contractors, labor, equipment, locations, costs, period of time, etc.

The system is further advantageous because it provides an easy way to track and be alerted to warranty information for numerous equipment and contractors. The system also allows for notification alerts of price discrepancies.

### BRIEF DESCRIPTION OF THE DRAWINGS

FIG. 1 is a schematic of the links between the customer, contractor, administrator and apparatus.

FIG. 2 is a line chart displaying total costs of all parts used.

FIG. 3 is a line chart displaying cost of specific types of equipment.

FIG. 4 is a line chart displaying the average costs of specific types of equipment.

FIG. 5 is a pie chart displaying cost of specific types of equipment as a percentage of total costs. 5 FIG. 6 is a line chart displaying the quantity of specific types of equipment used.

FIG. 7 is a line chart displaying the total cost of labor.

FIG. 8 is a pie chart displaying payment to contractor.

FIG. 9 is a line chart displaying the average costs of specific types of equipment and a reference value.

FIG. 10 is a flow chart of the processing steps of the present invention.

TABLE 1 is a table report of equipment

TABLE 2 is a table report of equipment

TABLE 3 is a table report of equipment costs

### DETAILED DESCRIPTION OF THE INVENTION

These and other objectives and advantages of the invention will appear more fully from the following description, made in conjunction with the accompanying figures. Although the disclosure hereof is detailed to enable those skilled in the art to practice the invention, the process and apparatus herein merely exemplify the invention, which can be embodied in other specific designs. Further, while the preferred embodiment has been described, the details may be changed without departing from the invention, which is defined by the claims.

As used herein, the term “customer” shall be taken to mean one who requests equipment or services, or for whom equipment is bought or services are performed

The term “equipment” shall be interchangeable with “part” and shall be taken to mean any machine, apparatus, or material that can be used by a customer or serviced by a contractor.

The term “service” shall be taken to mean any work requested by a customer or performed by a contractor.

The term “contractor” shall be taken to mean one who can provide services directly or indirectly.

### Apparatus

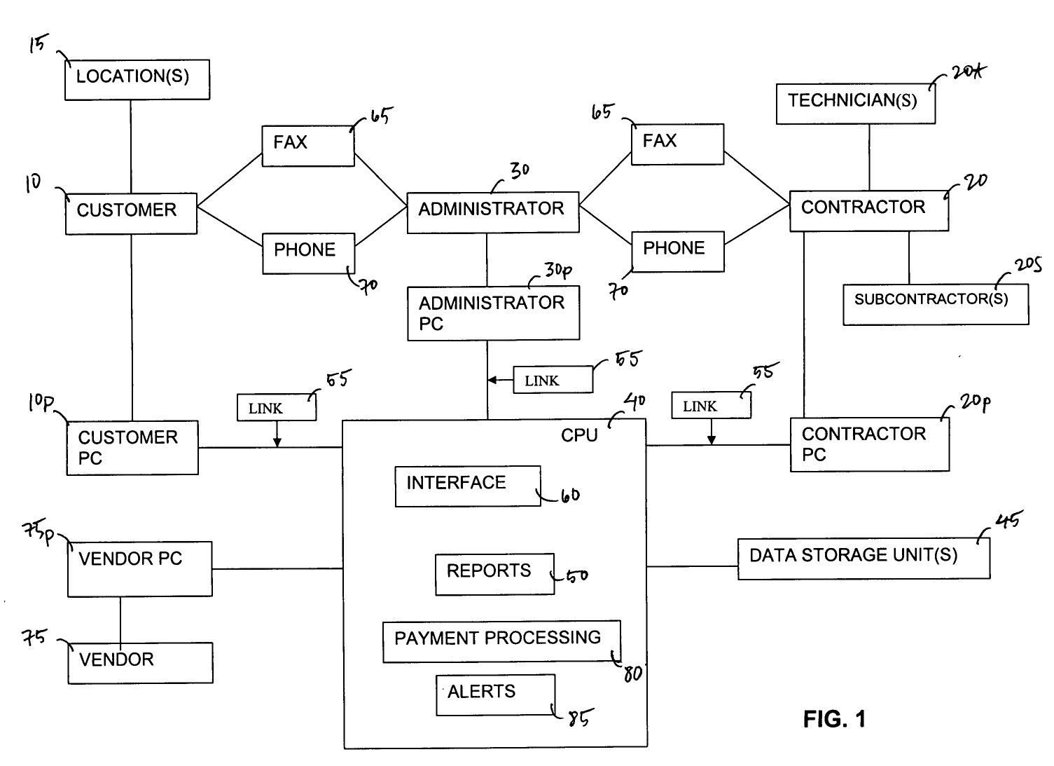

With reference to the drawings and to FIG. 1, there is shown a customer 10 with one or more locations 15 where service can be performed. A location 15 may be a physical address such as a residence or place of business, or it may be a virtual location such as a website or on a computer hard drive. A customer 10 communicates his desire for services by submitting a service request, or “service call”. Contractor 20 can respond to the service call and perform the service at customer's 10 location 15. Contractor 20 may be a sole proprietor or have one or more employee technicians 20t who can also perform the requested service. Alternatively, contractor 20 may subcontract the requested service to one or more subcontractors 20s. Contractor 20 may have himself, or provide to his technicians 20t or subcontractors 20s a global positioning satellite (GPS) receiver for locating and tracking the route taken to one or more service locations 15, and for tracking the time spent during transit and performing the service at each location 15.

FIG. 1 also shows administrator 30 who is responsible for facilitating the customer's 10 service call and the contractor's 20 performance, and for managing the information related thereto. Administrator 30 determines the pricing structure and the payments from the customer 10 and to the contractor 20. Also shown is a central processing unit (hereinafter “CPU”) 40, which is comprised of computer hardware and software configured and programmed by administrator 30. Another function of administrator 30 is to control permission to access CPU 40. CPU 40 is generally responsible for processing and archiving the service information in data storage unit 45 and for performing calculations and generating reports 50 based on said information. CPU 40 can exchange data with numerous communication devices. These communication devices include, but are not limited to, other CPUs, personal computers, personal digital assistants, blackberries, telephones, mobile phones, etc. (hereinafter collectively referred to as ‘PCs”). As illustrated in FIG. 1, customer PC 10p, administrator PC 30p, and contractor PC 20p, can receive and transmit data with CPU 40 via a communication link 55. A communication link 55 can be established using wires (phone, DSL, cable, or a direct computer to computer connection, etc.), or a wireless network (GSM, CDMA, satellite, Bluetooth, 802.11x, etc.). In the preferred embodiment, CPU 40 is accessible via the Internet, and a user can receive and transmit data to CPU 40 using any PC that is Internet enabled. It is envisioned that if a user does not own or have access to an Internet enabled PC, the user can contact administrator 30 via fax 65 or phone 70 to exchange data on his behalf. In this case the administrator 30 can exchange the user's data to and from CPU 40 using administrator PC 30. CPU 40 can transmit or receive data via any means available to it, including email, text message, computer facsimile, automated voice calling, or website.

Anyone who can receive and transmit data to CPU 40 is generally referred to as a “user”, including, but not limited to, customer 10, contractor 20, technician 20t, subcontractor 20, vendor 75, and administrator 30. A user exchanges information with CPU 40 via the “interface” 60. The CPU 40 and interface 60 is programmed by the administrator 30 to display certain information based on a user's account and status. For example, the interface 60 displays or omits certain information depending on the user's status as a customer 10, contractor 20, technician 20t, subcontractor 20, or administrator 30. The interface 60 allows users to log in to their account for viewing, inputting, and receiving information. Preferably, the interface 60 is a website located at a uniform resource locator (URL), or internet address, where a user logs in with a specific username and password.

CPU 40 has access to one or more databases and storage units hereinafter referred to a data storage unit 45. One of the functions of CPU 40 is to archive the service information in data storage unit 45. This may include, but is not limited to, a user's name and address, location(s), equipment, pricing, billing, and delivery information. Data may be stored mechanically, magnetically, optically, or any other means available. Preferably, data storage unit 45 is a computer hard drive. It is envisioned that the information in CPU 40 and data storage unit 45 will be accessible twenty-four (24) hours a day via a user's Internet enabled PC.

CPU 40 also communicates with a vendor 75 via vendor PC 75p. Vendor 75 may be a manufacturer, wholesaler, distributor, supplier or seller of equipment needed to perform the service. CPU 40 can communicate with vendor PC 75p to order equipment, exchanging information such as available parts, quantity needed, shipping, payment and billing.

CPU 40 also functions to communicate with a GPS locator, and other GPS tracking hardware and software, including mapping software, issued to contractor 20. In one embodiment, the GPS locator is issued to contractor 20 (or his technician 20t) at the beginning of the work day and turned in at the end of his shift. In another embodiment, the GPS locator is always with contractor 20, and can be turned on and off by him at appropriate times. Alternatively, the GPS locator can be paired with another device such as contractor's cell phone, personal digital assistant, or navigation system, etc. CPU 40 is programmed to track the location of a contractor 20, his route, and the time spent during transit and at customer's location 15. CPU 40 can track the GPS locator at all times, or only during the time of the performance of services, including transit to customer's location 15. By accessing CPU 40, a user can track in real time the location of contractor 20 on a map and the route he took to arrive at his present location. In another embodiment, CPU does not track the GPS locator in real time, but instead it is turned in at the end of the shift, and the data uploaded to CPU 40 for viewing and archiving. CPU 40 archives the GPS locator information in data storage unit 45 for later retrieval or for generating reports 50 based on said information. This gives accountability to, for example, the amount of time contractor 20 charged for labor.

CPU 40 is also programmed by administrator 30 for payment processing and billing functions 80. After service is completed and approved, CPU 40 effects payment to or from a user by receiving address and account information from data storage unit 45. CPU 40 can check for an existing account balance and to add or subtract the cost of the current work order as necessary. In one embodiment, CPU 40 comprises a printing device which can generate for example, a printed check to be mailed to the contractor 20, an invoice to be faxed to the customer 10, and a receipt indicating that user's account has been credited or charged. In the preferred embodiment, payments are sent and received electronically via credit card or Internet transfer. CPU 40 can send notice to a user via an email detailing the transaction or containing a URL for viewing the information at the interface 60. It is a feature of this invention that a user may select a desired payment or billing method from a number of different options.

Another function of CPU 40 is to create reports 50 that may be displayed on the interface 60, downloaded to a user's PC, and printed for the user's records. It is a feature of this invention that a report 50 can be based upon one or more users, locations, period of time, or any combination thereof. This information can be displayed in a number of graphical displays and made available to user in numerous file formats.

An example of a report 50 is one which is related the equipment used by customer 10 or serviced by contractor 20. The report 50 may include information such as the make and model, location, cost, date the equipment was initially installed, date the equipment was serviced, and warranty information. A customer 10 can create a report 50 to show equipment already installed at customer's location 15 and any replacement equipment used by contractor 20 to perform repairs or maintenance. Customer 10 may print out a report 50 to determine what parts were replaced for one or more locations 15 over a period of time, including the total cost of all parts. Additionally, customer 10 may simply view a report 50 to show all equipment and cost of each for all locations 15. An administrator 30 may print out a report 50 to determine what parts were sold to a particular contractor 20 within a given period of time. A contractor 20 may print out a report 50 to determine which parts were ordered for a specific customer 10, and the cost of each part.

For example, TABLE 1 shows equipment for a user(s) and lists the make and model, serial number, weight, and voltage of installed air conditioners (A/C) and universal power supplies (UPS). Also listed are the service parts (air filters and belts) that may need to be repaired or replaced for each A/C or UPS.

TABLE 2 shows details of the service parts used by one or more users over a period of time, including service call number (“WO#”), date, model number, serial number, part type, quantity and price. In one embodiment, TABLE 2 could be the service parts used at one or more locations. In other embodiments, TABLE 2 could be the service parts purchased by one or more customer, repaired by one or more contractors or subcontractors, and/or currently in place at one or more locations. It is a feature of this invention that the user determines which parameters they wish to view.

TABLE 3 is a summary that displays total quantity, cost, average price, and tax of each part type. Again, it is a feature of this invention that reports may be based on one or more users, locations, or period of time, or any combination thereof.

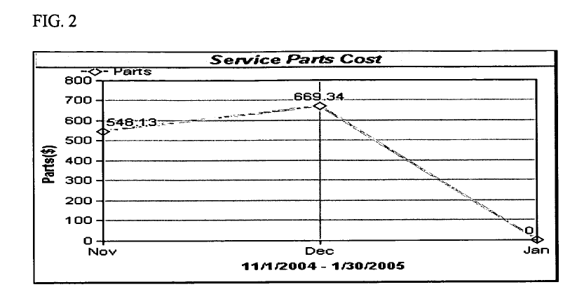

In addition to tables, CPU 40 can present information graphically. For example, cost can be plotted over time in a line chart. FIG. 2, shows a line chart that displays the total cost of all service parts used for each of three months.

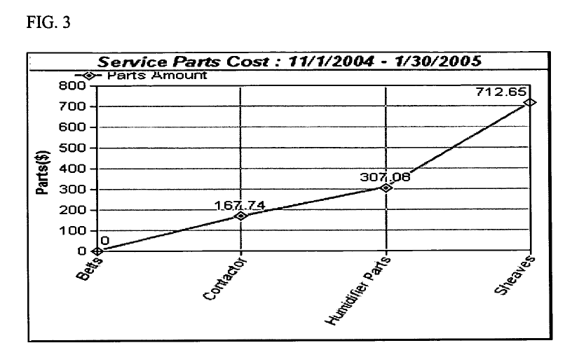

FIG. 3 is a line chart that plots specific types of equipment (belts, contactors, humidifier parts, and sheaves) vs the total costs for each.

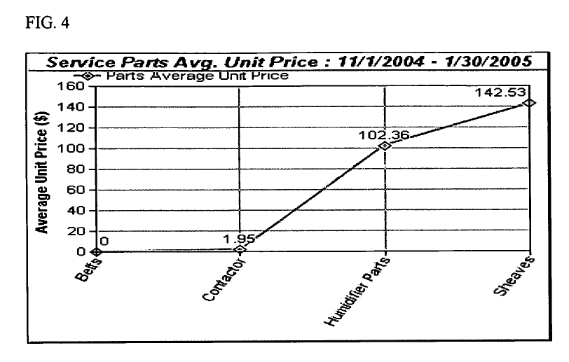

FIG. 4 shows a line chart that plots specific types of equipment vs the cost, on average, for each.

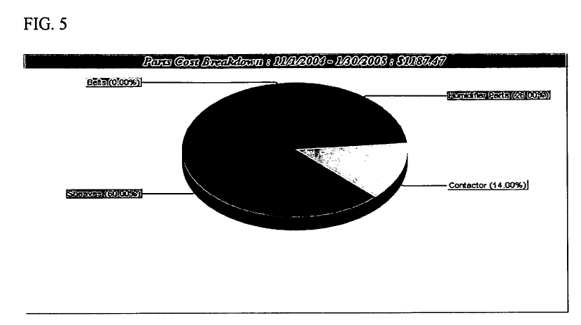

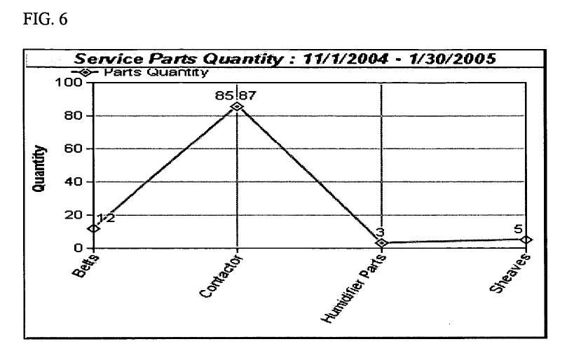

FIG. 5 is a pie chart showing the cost of specific types of equipment as a percentage of the total cost for all parts during the same time period.

FIG. 6 is a line chart that plots said specific types of equipment vs quantity used for service.

It is a feature of this invention that reports 50 may be presented in any number of formats, and is not limited to table, line, or pie charts, but may also include column, bar, and area charts, X-Y scatter plots, or even 3D surface plots where time and cost can be plotted against one or more users or locations.

With regard to the purchase of parts required to perform the service, said parts are preferably bought from administrator 30. To effect this, CPU 40 may communicate with vendor via vendor PC 75p to effect the sale of equipment to contractor 20. Preferably vendor is a manufacturer, but may also be a wholesaler, distributor, or other seller of equipment. When CPU 40 receives a quote from the contractor 20 for performing the service call, said quote may contain equipment needed to perform the service. By communicating with vendor PC 75p, CPU 40 can display a list of equipment available for purchase by contractor 20, execute the sale, and arrange delivery of the equipment to contractor 20.

It is envisioned that once CPU 40 compiles a history of purchased equipment over a period of time, a user can access this information via equipment reports 50 and anticipate future needs. A user can purchase parts in advance of this need, in bulk, and at a negotiated discount to retail prices. In one embodiment, a vendor may ship the equipment to the administrator 30 who in turn can make the parts available to the contractor 20. Preferably however, vendor holds the parts until CPU 40 sends instructions to ship directly to the contractor 20. Instructions to purchase and ship may be sent via email, text message, computer facsimile, automated voice calling, or be available at the interface 60, or posted at a website.

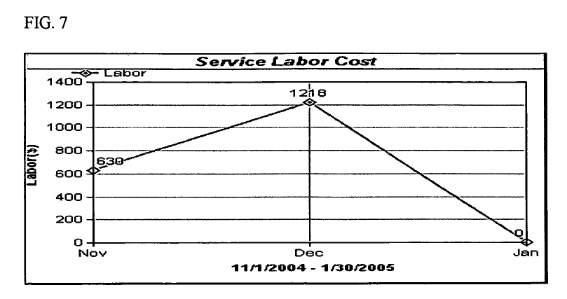

CPU 40 can generate reports 50 based on cost per hour of labor by contractor 20, technician 20t, or subcontractor 20. A labor report can be based on one or more users, locations or period of time, or any combination thereof. For example, administrator 30 or customer 10 can track the cost per hour for labor performed by a particular contractor 20 and the quantity of hours he spent on one or more service calls. With this information, the administrator 30 or customer 10 can negotiate with contractor 20 for a lower rate if it is envisioned a large amount of labor is regularly required. Similarly, a contractor 20 can track the cost of labor performed by a particular technician 20t or subcontractor 20. For example, FIG. 7 shows a line chart that plots the total cost of labor for each of three months for one or more technicians or subcontractor.

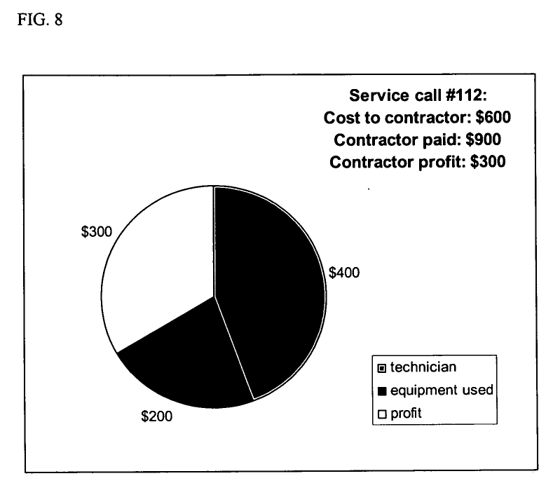

Another function of CPU 40 and the software running thereon is to generate profit reports. For a contractor 20 this may mean determining the profitability of one or more service calls or employee technicians 20t. When submitting a quote, in addition to pricing information related to labor and parts, contractor 20 may submit his burden for the specific technician 20t performing the service. The burden is the contractors's 20 cost of hiring the technician 20t, and may include hourly wage and overhead costs (rent, utilities, insurance, transportation, taxes, etc.), usually expressed as cost per hour. Contractor 20 may input this burden rate, or request CPU 40 to calculate the same by inputting overheard information and hourly wages for each technician 20t. In a simple example, suppose the burden rate for technician 20t is fifty dollars ($50) per hour. If said technician 20t performs an eight (8) hour service call, the cost to contractor 20 is four hundred dollars ($400) for said technician 20t. Suppose further that said technician 20t uses two hundred dollars ($200) worth of service parts, for a total cost of six hundred dollars ($600) to contractor 20. If administrator 30 pays contractor 20 nine hundred dollars ($900) for completing the service, contractor 20 profits three hundred dollars ($300). This is illustrated in a profit report such as FIG. 8, a pie graph which shows the cost to the contractor to hire a technician(s) for a particular service call ($400), the cost to contractor for equipment used by the technician ($200), the total amount paid to contractor for performing the service ($900), and the resulting profit to the contractor ($300). By generating a profit report for a particular technician 20t over multiple service calls, the contractor 20 can determine said technician's 20t productivity. By generating a profit report for a group of technicians 20t—for example those that work at night—contractor 20 can determine productivity for certain shifts or group of employees. CPU 40 can generate a profit report for a particular user, locations, over a period of time, or any combination thereof. It is envisioned that a profit report can be calculated during the quote submission process, enabling a contractor 20 to determine potential profit before dispatching the technician 20t. This may allow the contractor 20 to revise the quote as necessary or brief the technician 20t as appropriate. Contractor 20 may also determine the profitability of a subcontractor 20. Similarly, CPU 40 can generate a profit report for administrator 30 using the appropriate parameters.

CPU 40 is also programmed to send out alerts 85. Such an alert 85 is any communication to a user highlighting particular information, and could be embedded in other information or sent separately as an email, text message, or pop-up window at the interface 60, etc.

One such alert 85 warns a user of disparate pricing. As contractor 20 submits a quote for performing a service call, he inputs pricing information for labor and any parts. CPU 40 can be programmed to compare the inputted price against a reference value. This reference value may be determined by administrator 30 or automatically by CPU 40, and may be a national or local average price. In one embodiment, the reference value may be a price that the contractor 20 charged in the past for the same work. If the contractor's 20 pricing is a certain value or percentage beyond said reference value, CPU 40 is programmed to display this information on the interface 60 and/or send an alert 85 to user via user's PC. This price tracking system prevents any purported input errors by contractor 20 and promotes accountability. It also benefits the contractor 20 by alerting him of inputted prices that may be too low.

In another embodiment, CPU 40 is programmed to allow the user to input pricing information only within a certain range or reference value. For example, CPU 40 will not allow contractor 20 to submit a quote if the labor and/or equipment price is too high or too low as compared to the reference value.

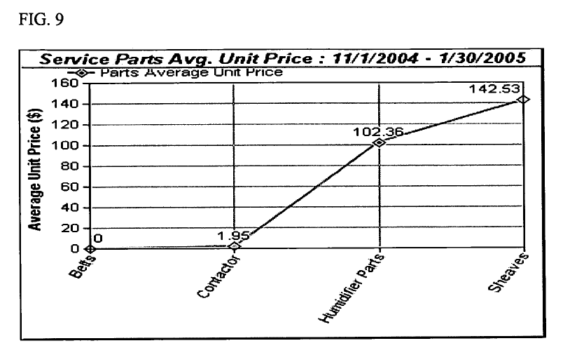

CPU 40 can also generate a report 50 showing said reference value. FIG. 9 shows a line chart that plots specific types of equipment vs the average cost for each. Also plotted on the same chart is the reference value as the national average price.

Users may display reports 50 over any given period of time, and can track parts usage or profit in the winter or summer months. Similarly, a user may display reports 50 based upon one or more manufacturers of equipment (identified by make and model), to determine the reliability of a manufacturer and their equipment. By generating the appropriate report 50, a user may be able to detect patterns such as the amount of time within which a certain manufacturer's product must be repaired or replaced, and during what time of the year. This information may be accessible on CPU 40 by the vendor 75 or manufacturer for a fee.

Another function of CPU 40 is to alert users of warranties such as for labor and parts. After contractor 20 performs service such as installation of equipment, CPU 40 records the date of performance. CPU 40 may request warranty information from the user (such as contractor 20 or vendor 75) or calculate it based on industry standards. If the contractor 20 later attempts to repair or replace the same equipment, or if service for the same equipment is requested by the customer 10, CPU 40 will communicate that the equipment is still covered under warranty or that the warranty has expired. CPU 40 can display the warranty information on the interface 60 and send an alert 85 to a user if a new service call is requested, for example, within a certain time of the last service. This warranty tracking gives accountability to contractor 20.

### Process

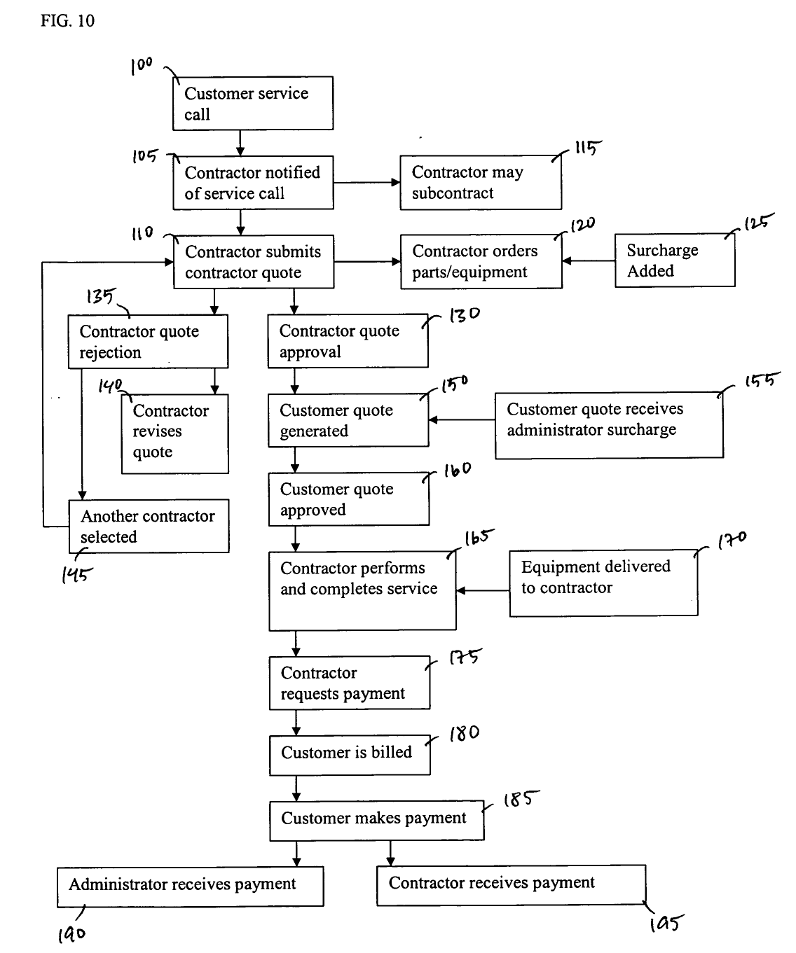

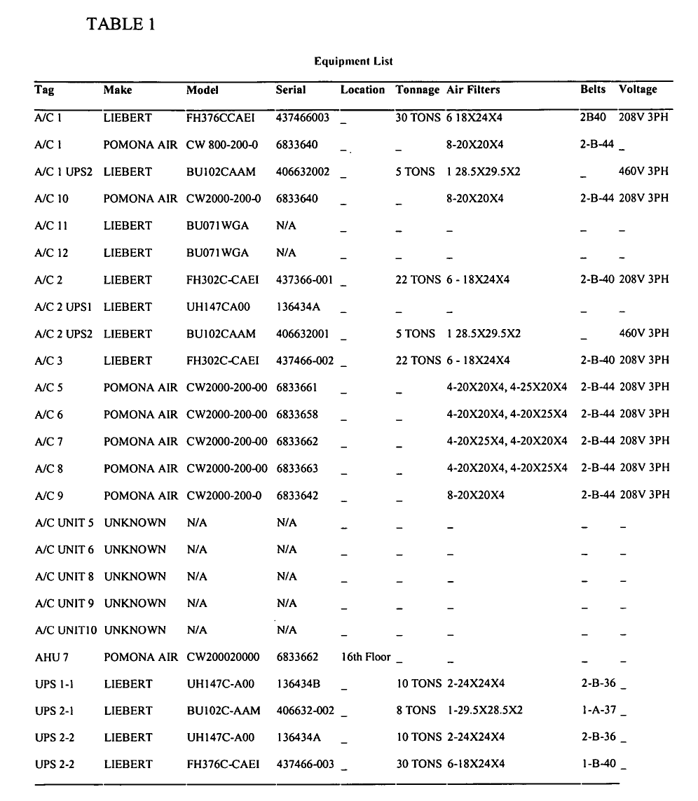

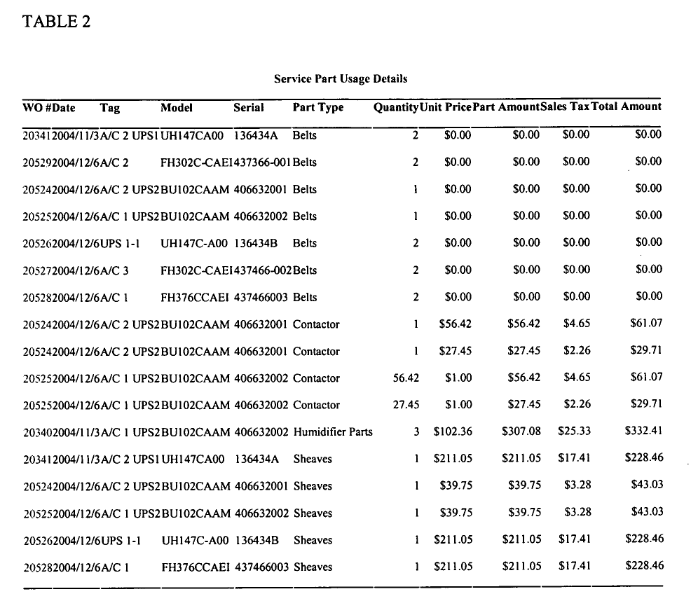

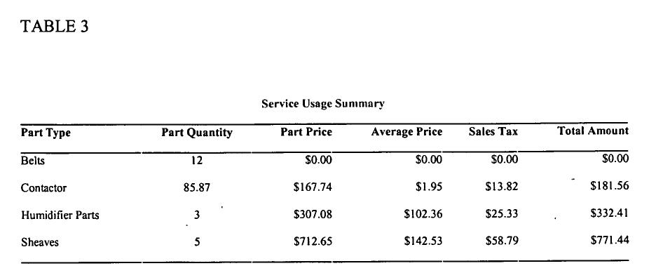

FIG. 10 is a flow chart of the processing steps of the present invention.

Customer is in need of service at one or more locations. As a result, customer wishes to request a service call 100, and desires to track the contractor's labor, parts, warranties, and accounting for said service. To do this customer uses apparatus and methods contained in the present invention. Customer starts the process by using customer PC and establishing a communication link with CPU to access the interface. In the preferred embodiment, an internet link is used to access CPU and effect the service call via a website.

Once communications are established between customer PC and CPU, a username and password are requested. Customer signs in to access an account and is presented with the interface upon which customer may view account information or request a new service call. In the preferred embodiment, the interface is a website which comprises a plurality of fields, both mandatory and optional to effect the service call. Mandatory fields request information which must be provided by the customer in order to effect the transaction and may include such information as customer name, location, equipment, and contractor. Optional fields may be special instructions, voluntary information, or information which, if not supplied, may be ascertained by administrator or determined by CPU. For example, if a contractor is not selected, CPU is programmed to select one based on proximity. It is envisioned that customer may input text and upload any necessary electronic files (documents, pictures, voice comments/instructions, video, etc.) to facilitate the service. It is also envisioned that the interface will access data storage unit to provide customer with a menu from which customer may choose available locations, equipment needed, equipment to be serviced, contractors, subcontractors, etc.

Once CPU has been provided all of the required information, CPU performs certain processing steps the first of which is to archive the service call information in data storage unit. CPU will also communicate the relevant information to contractor so that the contractor is notified of the service call 105. Preferably, CPU will notify contractor by sending an email or text message to contractor PC. CPU can also communicate by other means available to it, including but not limited to computer facsimile or automated voice calling. In another embodiment, CPU will send the information to administrator PC for receipt by administrator who can contact contractor to respond to the service call. CPU can also be scheduled to communicate a service call automatically for preventive maintenance at recurring intervals or a future date(s).

Once the contractor receives the service call (or before he performs preventive maintenance or other service which he initiates), the contractor establishes communication with CPU to submit a contractor quote for approval 110. If approved, this contractor quote is the amount the contractor can expect to be paid for completing the service, and may include labor, parts, surcharges, taxes, etc. In the preferred embodiment, contractor will contact CPU by following or clicking on a link, or embedded URL, sent to contractor PC via email. CPU may request a username or password before accessing the interface upon which contractor may view account information or respond to customer's service call. The interface will present the relevant information for performing the service and will request the contractor to input his information in a plurality of fields, both mandatory and optional. Mandatory fields may include the tax rate, pricing for labor, parts, and the contractor's surcharge for said parts. Optional fields may be special or additional data for input or upload such as the contractor's employee technician and contractor's burden rate for said technician. Alternatively, the contractor may subcontract the service call 115. It is envisioned that CPU will access data storage unit to provide contactor with a menu of available labor categories, parts, technicians, subcontractors, etc. from which he can choose.

At this point, the contractor may order the parts or equipment needed to perform the service 120. Contractor preferably buys them from administrator, who has pre-ordered them in advance, in bulk, and at a discount to contractor's normal suppliers. The interface will present to the contractor equipment for sale and CPU will effect the sale transaction. In one embodiment, contractor cannot submit a quote unless some or all of the parts required for service is bought from administrator. It is envisioned that when contractor submits a quote, contractor adds an increase in price, or contractor surcharge 125, to the cost of a service part. The value of the contractor surcharge associated with the part may be provided by the contractor, or calculated automatically by CPU. For example, the contractor surcharge may be a percentage of the cost of the part. Preferably, CPU calculates the contractor surcharge based on the local average surcharge for other contractors near customer's location.

In another embodiment, the customer may purchase the service parts from the administrator himself via the interface, with the absence or addition of any contractor surcharge mentioned above or administrator surcharged as discussed below.

After CPU has been provided all of the requested information by contractor to produce contractor quote, it performs certain processing steps, including calculating and communicating the total amount that the contractor can expect to be paid for performing the service based upon the data contractor inputted. The contractor may go back and change the information as necessary. Once satisfied, the contractor submits the quote to CPU which then archives it in data storage unit.

It is a feature of this invention that a user can generate any number of reports based upon the quote. For example, contractor may wish to display an expected profit report to determine the expected profit once the service is completed. With regard to the purchase of parts by administrator, administrator may command CPU to display an equipment report showing the price, type, and quantity of parts that were used or purchased within a period of time. Administrator may view the equipment report for one or more contractors, customers, vendors, locations, etc. It is envisioned that information contained in the equipment report will be indicative of future needs, and administrator can purchase the parts in advance of this need. With the information contained in the report, administrator can negotiate with vendor a discount for quantities bought in bulk. Preferably, vendor holds the parts bought by administrator until receiving a communication from CPU to ship them directly to contractor.

The next processing step involves approving the contractor quote 130, which may be done in a number of ways. The contractor quote can be communicated to the appropriate user, preferably administrator, via email notification to administrator's PC. The email contains a link, or embedded URL, which the user selects to retrieve contractor quote. User then reviews it for approval.

In the preferred embodiment, CPU can be programmed to approve the quote if it is within a certain range or less than a specific reference value. This range or reference value may be set by the administrator or calculated by CPU. For example, contractor's price may be compared against a national or local average, or against a value that the contractor charged in the past for the same work. If contractor's pricing is above said reference value, CPU is programmed to display this information on the interface and/or communicates an alert to the appropriate user, such as administrator, customer, or the contractor himself. Such an alert is any communication to a user highlighting the price and/or the price discrepancy, including email, text message, or pop-up window at the interface. This price tracking system prevents any purported input errors by contractor and promotes accountability. If contractor quote is rejected by administrator or CPU 135, contractor is notified and requested to revise the quote 140, or another contractor is solicited to respond to the service call 145. In another embodiment, CPU will not allow contractor to submit a quote if the labor, equipment, or total cost is too high or too low.

It is envisioned that if customer does not select a contractor, CPU or administrator may contact one or more contractors, inform them of the service call, and request each to submit a quote according to the above process. If two or more contractors respond to the same service call, administrator may choose one himself, or program CPU to select one based upon factors such as proximity to location, price quoted, etc. In another embodiment, an electronic auction format is used where the lowest quote is displayed, and each contractor has the opportunity to submit a lower quote. In yet another embodiment, CPU or administrator calculates an administrator quote which is communicated to one contractor who has a limited time to respond before it is sent to a second contractor. Or the administrator quote is communicated to more than one contractor in the area and approval to proceed with the service call is given to the first contractor who responds by submitting this administrator quote as his contractor quote.

After a contractor is selected and contractor quote is approved, a second quote, or customer quote, is generated 150. A customer quote is generated for the customer who requested the service or for whom the service is being performed. This customer quote contains the service information and is the amount the customer can expect to pay for the completed service, and may include labor, parts, surcharges, taxes, etc. The customer quote may be sent for customer's approval, administrator's approval, or automatically approved by CPU. Preferably, the customer quote will receive an administrator increase in price, or administrator surcharge 155, and the customer quote will cost more than the contractor quote. The administrator surcharge will be the amount the administrator can expect to be paid for facilitating the service. In the preferred embodiment, the customer quote and administrator surcharge will be determined by CPU as programmed by administrator. For example, CPU can calculate customer quote by adding contractor quote plus a percentage of contractor quote. To further this example, if contractor quote is nine-hundred dollars ($900), and the administrator surcharge is ten percent (10%) of contractor quote, CPU will calculate customer quote to be nine-hundred and ninety dollars ($990). It is expected that nine-hundred dollars ($900) will be paid to the contractor and ninety dollars ($90) to the administrator. In another embodiment, customer quote is increase by a set amount over the contractor quote. For example, if contractor quote is nine-hundred dollars ($900), and the administrator surcharge is set at seventy-five dollars, CPU will calculate customer quote to be nine-hundred and seventy five dollars ($975).

The percentage or set amount may increase (or decrease) depending on any number of factors as determined by administrator. In one embodiment, customers who request a high number of service calls or who have a high number of recurring service can be given a higher administrator surcharge (or be given an administrator discount).

The administrator surcharge can also be associated with the parts required to perform the service. After contractor quote is approved, the customer quote is created and another surcharge, an administrator's surcharge, is added to the part or equipment 125. This may be in addition to any surcharge by the contractor. The value of the administrative surcharge to the part is determined by administrator or calculated automatically by CPU.

The next step involves approving the customer quote 160. In one embodiment the customer quote is first approved by customer before contractor performs the service. In this case the customer quote is communicated to the customer preferably via a URL embedded in an email sent by CPU to customer PC. Customer then accesses the interface to review the customer quote and communicates his approval or disapproval. If rejected, contractor is notified to submit another contractor quote. Alternatively, another contractor is chosen to respond to the service call. If approved, a communication is sent to contractor to proceed with the service. In the preferred embodiment, contractor is notified via email or text message to contractor PC to proceed with the service. If parts are purchased from administrator, said equipment is delivered to contractor 170 either from administrator or preferably, directly from the vendor.

Contractor then performs and completes the service 165 using parts ordered from vendor or administrator, if any. Contractor then communicates with CPU to input the completed service and archive this information, and to request payment 175. Contractor may input text and/or upload any electronic file (documents, pictures, voice message, video, etc.) to show that the service was completed, assist in future service, or to recommend additional repairs. If the latter, contractor is requested to submit another quote for approval. At some point before or after completion of the service, warranty information is requested from contractor or vendor or calculated automatically by CPU for later retrieval and reference.

Customer is notified of the completed service preferably via email from CPU to customer PC. The notification may convey a message to the customer that the contractor has completed the service and the information has been archived for review at the interface, or the notification may present a copy of the completed service call and all related information. It is a feature of this invention that customer may access the interface and download electronic data in any number of available formats to be implemented or archived into their own system, or for presentations to upper management.

Once the service is completed by contractor, CPU bills customer 180 and customer makes payment 185. CPU also effects payment to administrator 190 and payment to contractor 195 by receiving address and account information from data storage unit. CPU can check for an existing account balance and add or subtract the cost of the last service as necessary. In one embodiment, CPU comprises a printing device which can generate for example, a printed check to be mailed to the contractor, an invoice to be faxed to the customer, and/or a receipt indicating that user's account has been credited or charged. In the preferred embodiment, payments are sent and received electronically via credit card or internet transfer. CPU can send notice via email to the appropriate user detailing the transaction or containing a URL for viewing the information at the interface. It is envisioned that user may select a desired payment or billing method from a number of different options.

It is a feature of this invention that a user can have more than one status, or role, in the above procedure. For example, a contractor can also be an administrator. In this scenario contractor uses subcontractor to perform one or more service calls. Thus, contractor uses the apparatus and process contained herein to be an administrator to said subcontractor. Similarly, said subcontractor may also subcontract the service call to other parties and himself be an administrator. A contractor can also be a vendor selling parts to customers and/or other contractors. A contractor himself can be a customer of other contractors.

All of the foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A system to effect service performed by a contractor for a customer comprising:
a. a central processing unit;
b. at least one PC;
c. a communications link between the central processing unit and the at least one PC to allow the central processing unit to exchange data with the at least one PC;
d. a data storage unit connected to the central processing unit for storing and retrieving the service information;
wherein the customer communicates a service request to the central processing unit, said central processing unit running thereon at least one computer program which: receives the customer's service request; transmits the service request to a contractor; receives a quote from the contractor for performing the service request; transmits approval to the contractor to perform the service request; receives information from the contractor regarding the completion of the service request; calculates and executes payment from the customer, to the contractor, and to the administrator, said administrator controlling permission to access the central processing unit and data storage unit.

2. The system of claim 1 wherein the PC comprises:
a personal computer.

3. The system of claim 1 wherein the PC comprises:
a mobile phone.

4. The system of claim 1 wherein the PC comprises:
a personal digital assistant.

5. The system of claim 1 wherein the communications link comprises:
the Internet.

6. The system of claim 1 wherein the communications link comprises:
a mobile phone network.

7. The system of claim 1 wherein the central processing unit transmits the service request to a contractor, said contractor selected among a plurality of contractors based upon the quotes submitted by each contractor.

8. The system of claim 1 wherein the central processing unit transmits the service request to a contractor, said contractor selected among a plurality of contractors based upon the proximity of contractor to customer.

9. The system of claim 1 wherein the central processing unit transmits the service request to a contractor, said contractor selected among a plurality of contractors based upon a bidding system where the current winning quote is displayed to the bidding contractors.

10. The system of claim 1 wherein the central processing unit transmits the service request to a contractor, said contractor selected among a plurality of contractors based upon the first contractor to respond to a pre-existing quote.

11. A system to effect the sale of equipment for service performed by a contractor for a customer comprising:
a. a central processing unit;
b. at least one PC;
c. a communications link between the central processing unit and the at least one PC to allow the central processing unit to exchange data with the at least one PC;
d. a data storage unit connected to the central processing unit for storing and retrieving the service information;
wherein the customer communicates a service request to the central processing unit, said central processing unit running thereon at least one computer program which: receives the customer's service request; transmits the service request to a contractor; receives a quote from the contractor for performing the service request, said quote containing equipment needed to perform said service; displays equipment available for purchase by contractor; executes the sale of equipment purchased by contractor; and arranges delivery of equipment to contractor.

12. The system of claim 11 wherein the needed equipment available for sale to contractor has been purchased in advance by administrator, in bulk, and at a discount to contractor's normal supplier.

13. The system of claim 11 wherein central processing unit communicates with vendor PC to execute the sale of equipment purchased by contractor

14. A system to display service information performed by a contractor for a customer comprising:
a. a central processing unit;
b. at least one PC;
c. a communications link between the central processing unit and the at least one PC to allow the central processing unit to exchange data with the at least one PC;
d. a data storage unit connected to the central processing unit for storing and retrieving the service information;
wherein the customer communicates a service request to the central processing unit, said central processing unit running thereon at least one computer program which: receives the customer's service request; receives information from the contractor regarding the completion of the service request; calculates and executes payment from the customer, to the contractor, and to the administrator, said administrator controlling permission to access the central processing unit and data storage unit; and generates a report.

15. The system of claim 14 wherein the report displays information comprising:
a. make and model;
b. location; and
c. cost;
of equipment.

16. The system of claim 15 wherein the report displays information further comprising:
a. the date the equipment was initially installed; and
b. the date the equipment was serviced.

17. The system of claim 15 wherein the report displays information further comprising equipment warranty information.

18. The system of claim 14 wherein the report displays information comprising:
a. cost per hour for labor; and
b. quantity of hours spent to perform the service.

19. The system of claim 14 wherein the report displays information comprising:
a. at least one technician hired by contractor to perform the service;
b. cost to contractor to hire the at least one technician;
c. cost to contractor for equipment used by the at least one technician to perform the service;
d. total amount charged by contractor for performing the service; and
e. the profit to the contractor for performing the service via technician.

20. A system to display any price discrepancy between the pricing information quoted by a contactor to perform service for a customer, and a reference value comprising:
a. a central processing unit;
b. at least one PC;
c. a communications link between the central processing unit and the at least one PC to allow the central processing unit to exchange data with the at least one PC;
d. a data storage unit connected to the central processing unit for storing and retrieving the service information;
wherein the customer communicates a service request to the central processing unit, said central processing unit running thereon at least one computer program which: receives the customer's service request; transmits the service request to a contractor; receives a quote from the contractor for performing the service request, said quote containing pricing information; compares the pricing information against a reference value; and sends a notification if there is a large price discrepancy between the pricing information and the reference value.

21. The system of claim 20 wherein the reference value is a national average price

22. The system of claim 20 wherein the reference value is a local average price in the location where customer receives the services

23. The system of claim 20 wherein the reference value is a price the contractor charged in the past for the same service.

24. The system of claim 20 wherein if there is a large price discrepancy between the pricing information and the reference value, CPU is further programmed to reject the quote from the contractor.

25. A system to track warranty information for equipment used by a customer and serviced by a contractor comprising:
a. a central processing unit;
b. at least one PC;
c. a communications link between the central processing unit and the at least one PC to allow the central processing unit to exchange data with the at least one PC;
d. a data storage unit connected to the central processing unit for storing and retrieving the service information;
wherein the customer communicates a service request to the central processing unit, said central processing unit running thereon at least one computer program which: receives the customer's service request; transmits the service request to a contractor; receives a quote from the contractor for performing the service request; transmits approval to the contractor to perform the service request; receives information from the contractor regarding the completion of the service request; requests warranty information, and sends a notification if the contractor later attempts to service the equipment within the warranty period.

26. A system to track the contractor's location, route taken, and time at customer's location comprising:
a. a central processing unit;
b. at least one PC;
c. a communications link between the central processing unit and the at least one PC to allow the central processing unit to exchange data with the at least one PC;
d. a data storage unit connected to the central processing unit for storing and retrieving the service information;
wherein the customer communicates a service request to the central processing unit, said central processing unit running thereon at least one computer program which: receives the customer's service request; transmits the service request to a contractor; receives a quote from the contractor for performing the service request; transmits approval to the contractor to perform the service request; connects to contractor's GPS locator; and receives information on the contractor's location, route taken, and time spent at customer's location.
